(19) United States
(12) Patent Application Publication
(10) Pub. No.: US 2021/0180454 A1
(43) Pub. Date: Jun. 17, 2021

(54) FEED APPARATUS AND METHOD FOR FEEDING CEMENT TO A CEMENT SILO

(71) Applicant: SANDVIK MINING AND CONSTRUCTION OY, Tampere (FI)

(72) Inventors: Sami JARVENTAUSTA, Tampere (FI); Jukka SIMILA, Tampere (FI); Tero YLI-HANNUKSELA, Tampere (FI)

(21) Appl. No.: 17/188,095

(22) Filed: Mar. 1, 2021

Related U.S. Application Data
(62) Division of application No. 16/068,822, filed on Jul. 9, 2018, now abandoned.

(51) Int. Cl. E21D 20/02; E21B 27/04; E21D 11/10; E21B 7/02; B65G 33/14; E21F 15/00

(52) U.S. Cl. CPC E21D 20/021; E21B 27/04; E21D 20/02; E21F 15/005; E21B 7/02; B65G 33/14; E21D 11/10

(57) ABSTRACT

A cement silo and feed apparatus for feeding cement to the cement silo of a mining machine includes a receptacle for receiving cement, a transfer tube connected at a first end of the receptacle for guiding the cement from the receptacle to the cement silo connectable at a second end of the transfer tube and transfer means arranged in connection with the transfer tube and arranged to move cement within the transfer tube from the receptacle to the cement silo. The transfer tube includes at least one transfer tube section having a tube-like inner space for cement to be transferred.

### RELATED APPLICATION DATA

This application is a divisional of U.S. patent application Ser. No. 16/068,822 filed Jul. 9, 2018, which is a §371 National Stage Application of PCT International Application No. PCT/EP2017/050550 filed Jan. 12, 2017 claiming priority to EP 16152020.0 filed Jan. 20, 2016.

### TECHNICAL FIELD

The present disclosure relates to a feed apparatus and a method for feeding cement to a cement silo, more particularly to feeding cement to a cement silo attached to a mining machine.

### BACKGROUND

In mining there are used grouting apparatuses both for grouting bolts in holes drilled for them and for injecting cement in holes or various fragmented rocks. Cement is usually fed from a lower part of a cement silo to a mixer, in which mixer the cement is mixed with water to produce grouting concrete. Typically, the cement silo is located on top of the mining machine, where it is relatively high up, whereby charging cement into the feed silo is hard, complicated and produces dust.

Additionally, it often requires manual assistance especially in underground mines with limited space available requiring a separate working platform usually reached by a ladder and may even concern cement sacks being lifted by manpower, which all may further risk the occupational safety of the operators.

### SUMMARY

An object of the present solution is to provide a method and a feed apparatus for feeding cement to a cement silo of a mining machine for implementing the method. The solution is based on the idea of providing the feed apparatus with a receptacle, a transfer tube and transfer means arranged to move cement within the transfer tube from the receptacle to the cement silo. This enables selecting more freely the point at which the cement is fed to the mining machine. This is very beneficial, because the space in mining tunnels is typically very limited and because of the problems related to feeding the cement directly to the cement silo typically positioned on top of the mining machine can be avoided.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

FIG. 1 is a perspective view of a mining machine according to the present disclosure with the feed apparatus in a tramming position.

FIG. 2 is a perspective view of the mining machine with the feed apparatus in a use position.

FIG. 3 illustrates a method for supplying cement to a cement silo attached to a mining machine according to the present disclosure.

FIGS. 4a and 4b illustrate schematically embodiments of the feed apparatus of the present disclosure.

### DETAILED DESCRIPTION OF THE INVENTION

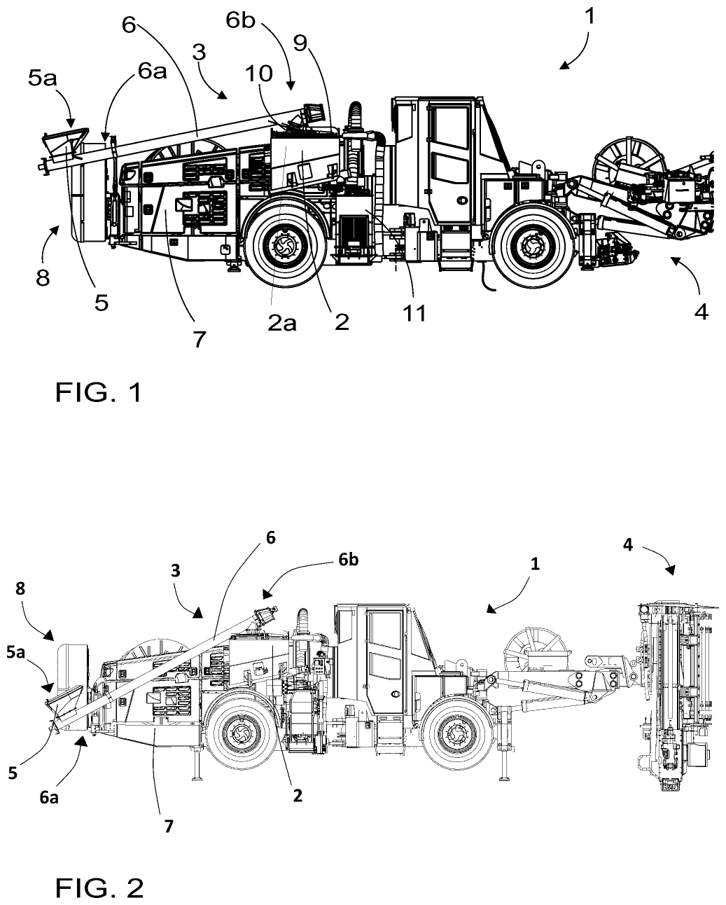

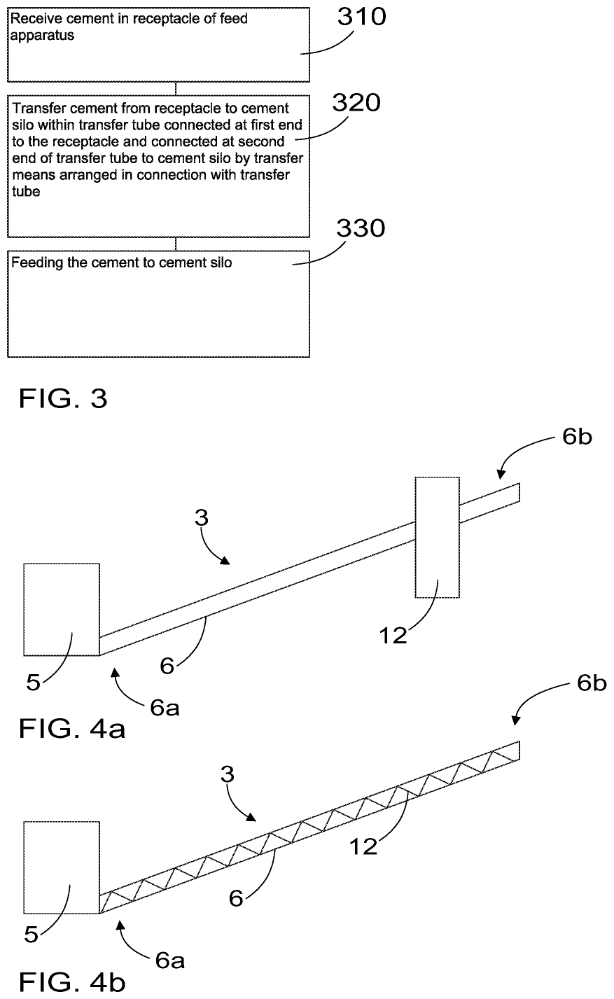

FIG. 1 shows a mining machine 1. The mining machine 1 may be any mining machine having means for providing grouting concrete to holes, splits and/or other cavities of a rock. Different embodiments of such mining machines 1 and means 4 for providing grouting concrete in cavities provided in a rock are known as such. The mining machine 1 may also include a mixer 11 for mixing cement and water for producing the grouting concrete and a cement silo 2 through which the cement is fed to the mixer 11.

The mining machine 1 of FIG. 1 also includes a feed apparatus 3 for feeding cement to the cement silo 2 of the mining machine 1. The feed apparatus 3 may have a receptacle 5 for receiving cement. According to an embodiment, the receptacle 5 may be a scoop-like container, wherein an opening 5a is arranged at the top of the receptacle 5 for receiving the cement. This enables easy filling of the cement to the receptacle 5.

The feed apparatus 3 may further includes a transfer tube 6 connected at a first end 6a to the receptacle 5 and connectable at a second end 6b to the cement silo 2 for guiding the cement from the receptacle 5 to the cement silo 2. The transfer tube 6 may be fixedly or removably attached to the receptacle 5 and/or the cement silo 2 for feeding cement to the cement silo 2. The transfer tube 6 may have at least one transfer tube section including a tube-like inner space for cement to be transferred. The transfer tube 6 enables positioning of the receptacle 5 for receiving cement at a desired position and, therefore, possibility for a more safe and convenient feeding of cement, as the cement does not need to be fed directly to the cement silo 2 or a receptacle provided above the cement silo 2.

According to an embodiment, the transfer tube 6 may have a transfer tube section and a connector part 6c for connecting the transfer tube 6 to the cement silo 2. According to another embodiment, the transfer tube 6 may further include a second transfer tube section. According to an embodiment, the transfer tube 6 may be at least two transfer tube sections arranged at an angle with respect to one another. These features enable more possible configurations and better fitting of the feed apparatus 3 with respect to the cement silo 2 and the frame part 7 of the mining machine 1.

According to an embodiment, at least a part of a transfer tube section of the transfer tube 6 may be formed as flexible at least in the transverse direction of the transfer tube section. The transverse direction of the transfer tube section may have a direction substantially perpendicular to the longitudinal direction of the transfer tube section. According to an embodiment, at least a part of the transfer tube section may be formed as flexible by the transfer tube section including a flexible material and/or a flexible structure.

According to an embodiment, the receptacle 5 may be provided as a fixed part of the feed apparatus 3. According to another embodiment, the receptacle 5 may have a separate unit that is removably arrangeable to the transfer tube 6. Different types of arrangements for removably arranging a receptacle to other structural parts are known as such and are not described here in more detail. In such embodiment, the receptacle 5 may be formed to be lifted to its use position by a fork-lift or other lifting apparatus known per se. Different types of lifting structures, such as lifting holes, lifting fixtures, lifting lugs, lifting hooks and the like are well known and are not described here in more detail.

The feed apparatus 3 may further have transfer means 12 arranged in connection with the transfer tube 6 and arranged to move cement within the transfer tube 6 from the receptacle 5 to the cement silo 2. The transfer means 12 may, thus, be arranged at least partly within the transfer tube 6 and/or at least partly surrounding at least one end of the transfer tube 6 or a point along the length of the transfer tube 6. According to an embodiment, the transfer means 12 may be a screw conveyor, such as it is schematically shown if FIG. 4b. In such an embodiment, the transfer means 12 may, thus, be arranged within the transfer tube 6. One benefit of such an embodiment is that it is cost efficient to provide.

According to another embodiment, the transfer means 12 may be an ejector, such as is schematically shown in FIG. 4a. In such an embodiment, the transfer means 12 may, thus, be arranged at least partly surrounding a point along the length of the transfer tube 6 and in fluid connection with it. Ejectors refer to pneumatic conveyors where overpressure and/or underpressure is used to provide a force moving a material. In such an embodiment, for instance overpressure may be provided at the first end 6a and/or underpressure may be provided at the second end 6b, such that the pressure difference between the first end 6a and the second end 6b of the transfer tube 6 pushes or pulls the cement within the transfer tube 6 from the receptacle 5 to the cement silo 2.

Ejectors and pneumatic conveyors as well as ways of providing overpressure and/or underpressure in connection with ejectors and pneumatic conveyors are known as such. The overpressure may be provided by some type of a blower and/or the underpressure may be provided by a suction compressor, for example. A benefit of such an embodiment is that it works well also with transfer tubes 6 that are not straight as shown in the figures but include tube sections arranged at an angle with respect to one another or have bends of some other type.

According to a further embodiment, the transfer means may include any other apparatus and/or structure known per se that is suitable for transferring cement inside a transfer tube also in an upwards inclined direction. These features further enhance the possibilities to position the feed apparatus 3 and especially the receptacle 5 for receiving the cement with respect to the mining machine 1, because the cement does not need to be fed to the cement silo 2 from above the cement silo 2, but the transfer means may convey the cement also in an upward or sideways direction. The feeding of the cement can, thus, be enabled in a more safe and convenient manner and also in more narrow and/or low mine tunnels. Also, a need for a separate loading position and a use position of the receptacle 5 and/or the cement silo 2 can be avoided, which also supports feeding cement also during a use phase of the mining machine 1.

Feed apparatus 3 may be arrangeable in at least two alternative positions with respect to the mining machine 1, such as in a first position being a tramming position and a second position being a use position. FIG. 1 shows an embodiment of feed apparatus 3 shown in the first position and FIG. 2 shows the feed apparatus in the second position.

The position of the receptacle 5 relative to a frame part 7 of the mining machine 1 in the tramming position may be closer to the midpoint of the mining machine 1 than in the use position in at least a vertical direction or a horizontal direction to optimise the overall dimensions of the mining machine. The position of the receptacle 5 relative to the frame part 7 of the mining machine 1 in the use position may similarly be located further away from the midpoint of the mining machine 1 than in the tramming position in at least a vertical direction or a horizontal direction to optimise the ease of feeding cement to the receptacle 5.

According to an embodiment, the receptacle 5 may be provided in a use position lower and more to the side from the longitudinal center line of the mining machine 1, whereby the receptacle 5 is easily available for feeding cement. In the tramming position, the receptacle 5 is provided closer to the longitudinal center line and higher up from the mine floor the mining machine 1 and thus may require less space when tramming in the tunnels and the receptacle 5 is less exposed to impacts.

According to an embodiment, the feed apparatus 3 may further include lifting means (not shown) for moving at least the first end 6a of the transfer tube 6 relative to the frame part 7 of the mining machine 1 and thereby moving the feed apparatus 3 between the use position and the tramming position.

According to an embodiment, the use position and the tramming position may be a use position and a tramming position as described above. According to an embodiment, the lifting means may include at least a pressure medium cylinder. Principles of such pressure medium cylinders are known as such and, thus, they are not explained in more detail.

According to an embodiment, the receptacle 5 is arranged in the vicinity of the back end 8 side of the mining machine 1. In other words, the receptacle 5 is arranged closer to the back end 8 of the mining machine 1, the back end 8 referring to the end of the mining machine 1 opposite to the end having means for providing grouting concrete.

The cement silo 2 according to the current solution may include a cover section 9 at the upper end of the cement silo 2 and at the cover section 9 a connecting part 10 shaped to be connected and sealed to the feed apparatus described in this description in a substantially dustproof manner

According to an embodiment, the transfer tube 3 may be connected and sealed to the connecting part 10 of the cover section 9. If the transfer tube 3 includes a connector part 6c, the connector part 6c of the transfer tube 3 and the connecting part 10 of the cover section 9 of the cement silo 2 may be connected and sealed to one another. The sealing is not necessary in all circumstances, but it further decreases presence of dust in the air and, thus, improves the working conditions.

A method for supplying cement to the cement silo 2 attached to a mining machine 1 may include the step of receiving cement in the receptacle 5 of the feed apparatus 3 at 310. The method may further include transferring at 320 the cement from the receptacle to the cement silo within a transfer tube connected at a first end to the receptacle and connected at a second end of the transfer tube to the cement silo by transfer means arranged in connection with the transfer tube, and feeding at 330 the cement to the cement silo. The transfer tube 6 may include at least one transfer tube section having a tube-like inner space for cement to be transferred. It should be understood that any feed apparatus 3 and/or a part thereof described in this description may be used in connection with the method.

According to an embodiment, the receptacle 5 may be provided at the back end 8 side of the mining machine 1 at least in the use position of the feed apparatus. The feed apparatus may be arranged in the use position of the feed apparatus 3 at least during a use phase of the mining machine 1, the use phase referring to a phase during operation of the mining machine 1. This use phase may include at least a phase during which cement is applied to the receptacle 5 of the feed apparatus 3.

According to an embodiment, cement is supplied to the cement silo 2 during use of the mining machine 1. In other words, cement is supplied to the cement silo 2 simultaneously to providing grouting concrete to holes, splits and/or other cavities of a rock, for example. The use phase may, thus, also include providing grouting concrete to a rock.

According to an embodiment, the cement silo 2 includes a sensor (not shown) for detecting the fill-level of the cement silo 2. The method for supplying cement to cement silo 2 attached to a mining machine 1 may further include sensing the fill-level of the cement silo 2 and controlling automatically the transfer means of the feed apparatus 3, such that the volume of the cement fed by the transfer means is lowered or the function of the transfer means is stopped when a predetermined upper control limit of the fill-level of the cement silo 2 is exceeded and the volume of the cement fed by the transfer means is increased or the function of the transfer means is started when the fill-level of the cement silo 2 has fallen below a predetermined lower control limit.

According to a further embodiment, the method may include sensing the fill-level of the cement silo 2 and giving a warning for an operator of the mining machine 1 when a predetermined upper control limit of the fill-level of the cement silo or a predetermined lower control limit of the fill-level of the cement silo controlling has been reached.

Although the present embodiments have been described in relation to particular aspects thereof, many other variations and modifications and other uses will become apparent to those skilled in the art. It is preferred therefore, that the present embodiments be limited not by the specific disclosure herein, but only by the appended claims.

What is claimed is:

1. A cement silo of a mining machine, the cement silo comprising:
a cover section located at an upper end of the cement silo, wherein the cement silo includes a connecting part shaped and arranged to be connected and sealed to a feed apparatus in a dustproof manner, wherein the feed apparatus is arranged for feeding cement to the cement silo, the feed apparatus including a receptacle arranged to receive cement, the receptacle being disposed at a rear end of the mining machine, a transfer tube connected at a first end to the receptacle and arranged to guide the cement from the receptacle to the cement silo, which is connected to a second end of the transfer tube, the transfer tube having at least one transfer tube section including a tube-like inner space for cement to be transferred therethrough, and a transfer device arranged in connection with the transfer tube and arranged to move cement within the transfer tube from the receptacle to the cement silo.

2. The cement silo of claim 1, wherein the receptacle includes a scoop-like container, wherein an opening is arranged at a top of the receptacle for receiving the cement.

3. The cement silo according to claim 1, further comprising a connector part arranged to connect the transfer tube to the cement silo.

4. The cement silo according to claim 1, wherein the at least one transfer tube section comprises at least two transfer tube sections arranged at an angle with respect to one another.

5. The cement silo according to claim 1, wherein at least a part of the at least one transfer tube section is flexible in at least in a transverse direction of the transfer tube section, the flexible part of the transfer tube section being a flexible material and/or a flexible structure.

6. The cement silo according to claim 1, wherein the transfer device is a screw conveyor.

7. The cement silo according to claim 1, wherein the transfer device is an ejector.

8. The cement silo according to claim 1, wherein the feed apparatus is movable between at least two alternative positions with respect to the mining machine, a first position being a tramming position and a second position being a use position, wherein the position of the receptacle relative to a frame part of the mining machine in the tramming position is closer to a midpoint of the mining machine than in the use position in at least a vertical direction or a horizontal direction to optimize overall dimensions of the mining machine, and wherein the position of the receptacle relative to the frame part of the mining machine in the use position is further away from the midpoint of the mining machine than in the tramming position in at least a vertical direction or a horizontal direction and parallel to mining machine to optimize ease of feeding cement to the receptacle.

9. The cement silo according to claim 1, wherein the receptacle is arranged at the vicinity of a back end side of the mining machine.
